(19) United States
(12) Patent Application Publication
(10) Pub. No.: US 2010/0095288 A1
(43) Pub. Date: Apr. 15, 2010

(54) METHOD FOR UPDATING SOFTWARE OF IMAGE DEVICE

(76) Inventor: Ki-Hoon Kim, Gumi-city (KR)

Correspondence Address: BIRCH STEWART KOLASCH & BIRCH, PO BOX 747, FALLS CHURCH, VA, 22040-0747, US

(21) Appl. No.: 12/443,574

(22) PCT Filed: Sep. 3, 2008
(86) PCT No.: PCT/KR08/05195

§ 371 Date: Mar. 30, 2009

(51) Int. Cl. G06F 9/44

(52) U.S. Cl. 717/168

(57) ABSTRACT

Provided is a method for updating software of an image device that allows a user to set whether to update the software. In the method, over the air (OTA) data including software update information are received. A digital storage media-command and control (DSM-CC) section table among the received over the air (OTA) data is parsed. A predetermined field inside the digital storage media-command and control (DSM-CC) section table is checked. Whether to perform software update regardless of whether to perform update set by the user is judged as a result of the checking. Software update is performed depending on a result of the judgment.

### TECHNICAL FIELD

The present disclosure relates to an image device. The image device can receive software data using over the air (OTA) or over air download (OAD). Particularly, the present disclosure relates to a method for updating software required by the image device.

### BACKGROUND ART

Recently, an image device providing a high image quality and high quality image and various functions is rapidly distributed.

Also, as a user interface or the function of the image device is diversified, it is frequently required to update software of the image device. With this trend, technology of putting data for updating software in a broadcasting signal transmitted from a broadcasting station to allow the software of the image device to be updated is under development.

Also, in updating the software, a user can determine whether to execute updating of the software, and can also set an update time.

That is, in the case where software update data are included in a broadcasting signal received by the image device, the image device provides the user with an interface for updating the software.

Also, even in the case where software update data are included in a broadcasting signal, the user can continue to view a broadcasting program currently viewed instead of updating the software. That is, the user can set in advance whether to perform software update.

Meanwhile, in the case where the user sets such that the software of the image device is not updated, a fatal error may be caused to the image device itself.

That is, in case of correcting a fatal error caused to the software of the image device, or in the case where a broadcasting signal transmission standard of a broadcasting company changes, a corresponding updating operation should be performed.

Consequently, even when software has to be updated for a normal operation of the image device, where a user sets such that the software update is not performed, the software update is not performed and so the image device may not normally operate.

FIG. 1 is a flowchart explaining a software update operation performed in a related art image device.

The image device can receive broadcasting signals including a software update signal according to OTA or OAD. When the user receives broadcasting signals of a channel currently viewed (S101), the image device displays image signals included in the broadcasting signals on a screen.

Also, the image device checks whether data for software update are included in the received broadcasting signals (S102), and when the data for software update are included in the received broadcasting signals, the image device checks user set contents regarding software update (S103).

When a user is set to perform software update as a result of the checking (S104), update data included in the broadcasting signals are downloaded according to an OTA routine to allow the software of the image device to be performed (S105).

Meanwhile, even when the software update is indispensably required, where a user is not set to download the update data or to update the software, the image device does not update the software (S106).

In the case where the software update inside the image device is so important as to normally operate the image device, the image device may not be normally operated due to a false setting by the user.

### DISCLOSURE OF INVENTION

### Technical Problem

Embodiments provide a method for updating software that allows an update operation to be performed in spite of a user's setting in case of indispensable updating, even when software update is set not to be performed by the user's setting.

### Technical Solution

In one embodiment, a method for updating software of an image device that allows a user to set whether to update the software, includes: receiving over the air (OTA) data including software update information; parsing a digital storage media-command and control (DSM-CC) section table among the received over the air (OTA) data, and checking a predetermined field inside the digital storage media-command and control (DSM-CC) section table; judging whether to perform software update regardless of whether to perform update set by the user as a result of the checking; and performing software update depending on a result of the judgment.

In another embodiment, a method for updating software of an image device that allows a user to set whether to update the software, includes: receiving over the air (OTA) data including software update information; parsing download service initiate information (DSI) among the received over the air (OTA) data, and checking a descriptor inside the download service initiate information (DSI); and performing software update regardless of whether to perform update set by the user depending on a result of the checking.

The details of one or more embodiments are set forth in the accompanying drawings and the description below. Other features will be apparent from the description and drawings, and from the claims.

### ADVANTAGEOUS EFFECTS

The software update method according to an embodiment allows software update of an image device related to indispensable updating to be forcibly updated, thereby normally operating the image device.

Also, according to an embodiment, even when a specific function of an image device is added or deleted due to a change in a standard of a broadcasting company, corresponding software can be readily applied, so that a user does not need to inconveniently perform an operation for software update.

### BRIEF DESCRIPTION OF THE DRAWINGS

FIG. 1 is a flowchart explaining a software update operation performed by a related art image device.

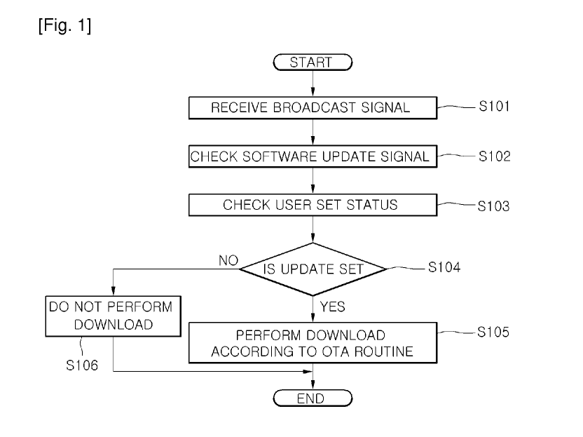

FIG. 2 is a block diagram explaining an image device according to an embodiment.

FIG. 3 is a view explaining a software update method of an image device according to an embodiment.

FIG. 4 is a view illustrating syntax of a DSM-CC section format according to an embodiment.

FIG. 5 is a view illustrating a DSI descriptor according to another embodiment.

### MODE FOR THE INVENTION

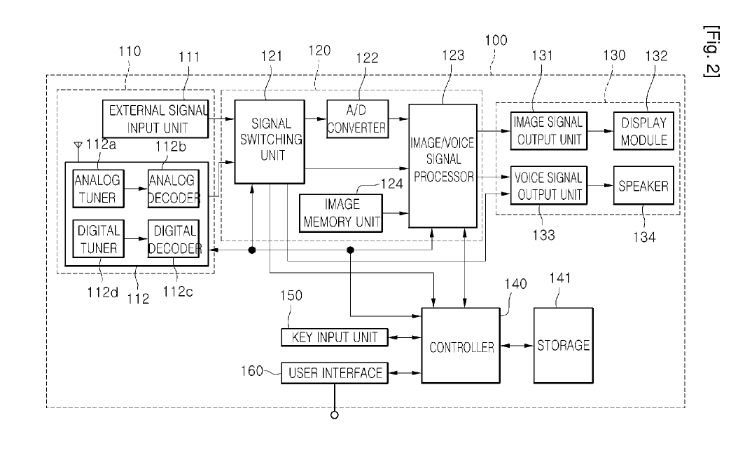

FIG. 2 is a block diagram explaining an image device according to an embodiment.

Referring to FIG. 2, the image device includes a receiver 110, a processor 120, an output unit 130, a controller 140, a storage 141, and a user interface 160.

The receiver 110 can include an external signal input unit 111 for receiving image or voice signals from an external signal source, and a tuner unit 112 for receiving signals transmitted from a broadcasting station.

The external signal input unit 111 receives an external signal received from an external device such as a digital versatile disk (DVD), a setup box, and a camcorder, and provides the same to a signal switching unit 121.

Also, the tuner unit 112 tunes at least one channel in response to a control signal of the controller 140, and separates signals received through the tuned channel into image/voice/data signals, and provides them to the signal switching unit 121.

A data signal included in signals provided through the tuner unit 112 includes electronic program guide (EPG) information including a start time and an end time of a broadcasting program broadcasted through each channel. Also, the tuner unit 112 receives data for updating software of the image device according to OTA or OAD together with broadcasting signals.

The data signal can be deciphered as data information by decoding. Program information, which is a portion of the data information, is transferred to the controller 140 directly or indirectly. The controller 140 can explore another channel through which the same contents as those broadcasted in a current channel are broadcasted using the program information.

Also, the tuner unit 112 can include an analog tuner 112a receiving an analog signal, an analog decoder 112b (for example, a National Television System Committee (NTSC) decoder) decoding an analog signal, and a digital decoder 112c (for example, a vestigial sideband (VSB) decoder) decoding a digital signal, together with a digital tuner 112d receiving a digital signal.

Image/voice signals input through the VSB decoder has the form of a transport stream (TS).

Meanwhile, the processor 120 can include a signal switching unit 121, an analog/digital (A/D) converter 122, an image/voice signal processor 123, and an image memory unit 124. As described above, the signal switching unit 121 selects at least one channel from channels provided by the external signal input unit 111 and the tuner unit 112, and separates signals of the selected channel into image and voice signals if necessary, to provide them to the image/voice signal processor 123.

The signal switching unit 121 includes a demultiplexer separating image signals, voice signals, and data signals from received signals.

In the case where a signal selected by the signal switching unit 121 is an analog signal, the analog signal is separated into an image signal and a voice signal. The separated analog signals are converted into digital image signals by an A/D converter 122, and then provided to the image/voice signal processor 123.

Also, a separated analog voice signal is output through a voice signal output unit 133.

In the case where a signal selected by the signal switching unit 121 is a digital signal, a digital image signal and a digital voice signal are provided to the image/voice signal processor 123 including an MPEG decoder.

The image/voice signal processor 123 recovers image and voice streams of output signals of the signal switching unit 121 to image and voice data and processing the same, and the processed image signal is output through an image signal output unit 131, and the processed voice signal is output through the voice signal output unit 133.

The image memory unit 124 provides a memory region required for decoding and signal processing by the image/voice signal processor 123, and particularly, can be used in case of exploring another channel through which the same contents as those in a storage 141 are broadcast, and is used for comparing the sameness of two or more channels in their contents.

The output unit 130 is a means for outputting image and voice signals to a user, and includes image and voice signal output units 131 and 133, a display module 132, and a speaker 134.

The controller 140 checks data included in broadcast signals received through the receiver 110, and judges whether software update information and data are included within the data. Also, the controller 140 allows data for updating a software of the image device 100 to be stored.

Specifically, the controller 140 receives a DSM-CC section format table included in received broadcast signals, and checks a specific flag value inside the DSM-CC section format table.

When the specific flag value set in advance inside the DSM-CC section format table is a designated value, the controller 140 stores corresponding update data to allow software update to be performed.

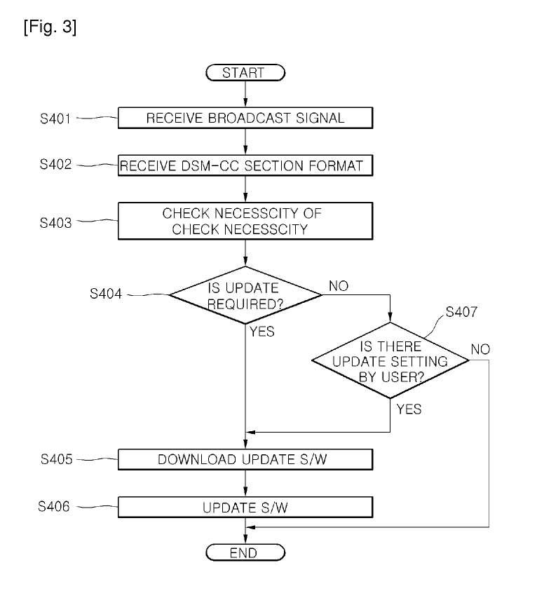

A process of updating software at the image device 100 is described in more detail with reference to FIG. 3.

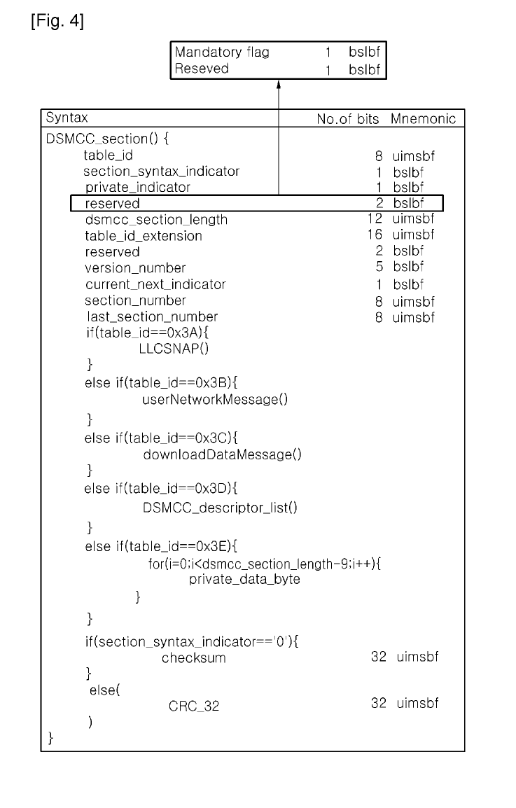

FIG. 3 is a view explaining a software update method of an image device according to an embodiment, and FIG. 4 is a view illustrating a syntax of a DSM-CC section format according to an embodiment.

A DSM-CC section format table according to the embodiment is illustrated in FIG. 4. According to the embodiment, information as to whether software update is indispensable is expressed using reserved 2 bits inside a descriptor.

That is, there is a 2-bit reserved term on the DSM-CC section format table of OTA standard, and a flag value can be designated to 0 or 1 using the 2-bit reserved term, so that whether software update is indispensable is determined depending on the reserved bit value is 0 or 1.

The image device according to the embodiment receives broadcast signals (S401), and reads DSM-CC section format table included in the broadcast signals (S402).

Next, the image device checks a reserved descriptor inside the DSM-CC section format table to check whether the flag value is 0 or 1. That is, the image device checks whether to forcibly update software of the image device using update data being received (S403).

For example, in the case where a mandatory flag (reserved) inside the DSM-CC section format table is 1, corresponding update data are downloaded so that software of the image device is updated regardless of whether update is set by a user. Therefore, download of the software is performed and software stored already stored in the storage 140 of the image device is updated.

That is, according to the embodiment, a flag corresponding to information regarding forced software update is inserted into a region that allows a user input besides coding defined in advance inside the DSM-CC section format table.

Also, in the case where the mandatory flag is 0, update data are downloaded depending on whether update is set by the user.

That is, whether software update is indispensable is judged depending on a flag value set in advance inside the DSM-CC section format table (S404).

In the case where software update of the image device is indispensably required as a result of the judgment, received update data are downloaded (S405), and update of the image device is performed using the download-completed updated software (S406).

On the other hand, in the case where the flag of the reserved descriptor inside the DSM-CC section format table is not indispensable, whether the user has set software update through OTA or OAD is checked (S407). In this case, when whether to perform software update has not been set by the user, a predetermined message or voice is output to the user, so that whether to perform software update can be confirmed.

Also, update software is downloaded or software update of the image device is not allowed to be performed depending on information set by the user.

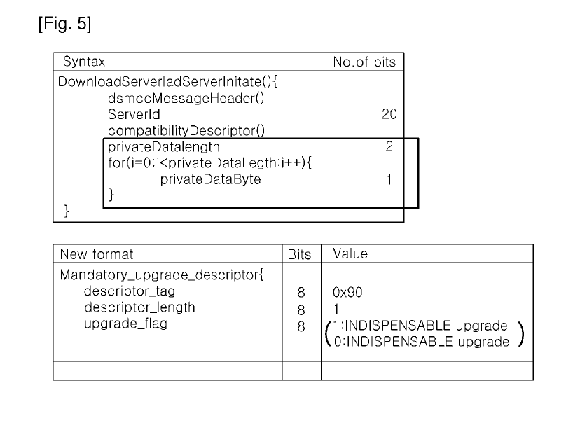

FIG. 5 is a view illustrating a DSI descriptor according to another embodiment.

Referring to FIG. 5, a privateDataByte portion in the format of DSI of DSM-CC is a portion that can be coded by a developer, and used through additional coding, so that it can execute coding for controlling definition, selection, and download of broadcast signals.

Therefore, similarly to FIG. 4, a flag for download of software included in broadcast signals and forced execution of update regardless of a menu setting by a user is set in the privateDataByte region of FIG. 5.

Also, the controller 140 parses DSI information from data included in broadcast signals to check upgrade_flag. The controller 140 checks a descriptor inside the privateDataByte inside the parsed DSI information to check the upgrade_flag is 0 or 1.

For example, when the upgrade_flag value is 1 as a result of checking the descriptor of the privateDataByte, it represents indispensable upgrade (update), and received update software is downloaded regardless of whether update is set by a user.

On the other hand, when the upgrade_flag value is 0, it represents a general upgrade, so that whether to download corresponding update software is determined depending on whether to perform software update set by the user.

Also, the proposed descriptor further includes tag and length information besides the upgrade_flag.

Meanwhile, whether update software is included in broadcast signals can be checked while a channel of the image device is changed. Also, besides the time of the channel change, whether software is included in broadcast signals corresponding to all the channels is judged periodically, and when software is included in broadcast signals received from a specific broadcasting station, the inclusion of the software can be informed to a user through a corresponding message.

Also, even when software is included in broadcast signals, where software is already updated in the image device 100 of the user, or software of the same version as that of the software included in the broadcast signals is included in the image device 100, a process may not be proceeded further.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The above described embodiments can be applicable to a display device that can receive broadcast signals, and thus they have industrial applicability.

1. A method for updating software of an image device that allows a user to set whether to update the software, the method comprising:
receiving over the air (OTA) data including software update information;
parsing a digital storage media-command and control (DSM-CC) section table among the received over the air (OTA) data, and checking a predetermined field inside the digital storage media-command and control (DSM-CC) section table;
judging whether to perform software update regardless of whether to perform update set by the user as a result of the checking; and
performing software update depending on a result of the judgment.

2. The method according to claim 1, wherein the predetermined field inside the digital storage media-command and control (DSM-CC) section table comprises a 2-bit reserved field.

3. The method according to claim 1, further comprising, when a flag value of the field is not a predetermined value as a result of the checking of the predetermined field inside the digital storage media-command and control (DSM-CC) section table, performing software update depending on information set by the user.

4. The method according to claim 1, further comprising, when software update is performed depending on whether to perform update set by the user as a result of the checking of a reserved field inside the digital storage media-command and control (DSM-CC) section table, outputting a predetermined message or voice.

5. A method for updating software of an image device that allows a user to set whether to update the software, the method comprising:
receiving over the air (OTA) data including software update information;
parsing download service initiate information (DSI) among the received over the air (OTA) data, and checking a descriptor inside the download service initiate information (DSI); and
performing software update regardless of whether to perform update set by the user depending on a result of the checking.

6. The method according to claim 5, wherein the descriptor of the download service initiate information (DSI) comprises a flag representing information regarding necessity of software update.

7. The method according to claim 5, wherein the descriptor is written in privateDataByte inside over the air (OTA) standard.
